(19) United States
(12) Patent Application Publication
(10) Pub. No.: US 2003/0234021 A1
(43) Pub. Date: Dec. 25, 2003

(54) Self-contained flow controlling mechanism of oxygen treatment device

(76) Inventor: Kuo-Chung Cheng, Ba-De City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/178,365

(22) Filed: Jun. 25, 2002

(51) Int. Cl. A62B 9/02

(52) U.S. Cl. 128/205.24

(57) ABSTRACT

A flow controlling mechanism of an oxygen treatment device includes an inflow control valve connected to a first conduit at an outlet thereof; the first conduit is connected to a hood. The inflow control valve has an adjustment member constructed in such a manner as to be able to make size of the opening of an inlet of the valve vary with force of the patient breathing in the oxygen in substantially direct proportion. An outflow control valve of the flow controlling mechanism is connected to a second conduit at an inlet thereof; the second conduit is connected to the hood. The outflow control valve has an adjustment member constructed in such a manner as to be able to make size of the opening of an outlet of the valve vary with force of the patient breathing out gas in substantially direct proportion.

### BACKGROUND OF THE INVENTION

The present invention relates to a self-contained flow controlling mechanism of an oxygen treatment device, and more particularly a self-contained flow controlling mechanism of an oxygen treatment device, which is provided for use together with hyperbaric oxygen chamber, and is constructed in such a manner as to be able to control flow of gas according to the force of breathing of the patients.

Hyperbaric oxygen is a treatment in which patients breathes gas containing up to 90% oxygen at greater than atmospheric pressure in a large chamber. Such chamber usually has several seats disposed therein so that the patients can be seated while receiving the hyperbaric oxygen treatment in the chamber. Because oxygen is relatively expensive and combustible, it will be a waste of money and dangerous to fill the chamber with hyperbaric oxygen. Therefore, supplementary oxygen treatment devices are provided, which include a hood (FIG. 7) or a respirator (FIG. 8), and a flow controlling mechanism that is connected to the oxygen outlets of the chambers with conduits; thus, the patients can put on the hoods to breathe oxygen without the need of filling the chamber with oxygen.

Referring to FIGS. 9 and 10, a conventional supplementary oxygen treatment device includes a flow controlling member 3 and a hood 4. The flow controlling member 3 includes an inlet pipe 31, an adjustment knobs 32, and 38, flow meters 34, and 35, and an outlet pipe 36. The inlet pipe 31 is to be connected to the gas outlet of a chamber, and is connected to the adjustment knobs 32 at the inner end. The adjustment knobs 32 are connected to a three-way tube 33 for adjusting the flow of oxygen traveling through the tube 33 with. Conduits are used to connect the flow meters 34, and 35 to the three-way tube 33 so that oxygen can be sent through the flow meters 34, and 35, which will read the flow of the oxygen. The flow meter 34 is connected to the outlet pipe 36. And, a first conduit 41 is provided to connect the outlet pipe 36 to the hood 4 so that oxygen can be sent to the hood 4 for the use of the patient. The flow meter 35 is connected to a humidifier 37, which is also connected to the outlet pipe 36, so that part of the oxygen can be humidified before it is sent into the hood 4. A second conduit 42 is connected to the hood 4 and the adjustment knob 38 at two ends, and the knob 38 is connected to an exhaust pipe 39; thus, the gas breathed out of the patient can be sent to outside, and the flow of the gas can be controlled by means of the knob 38.

However, the hood 4 consists of relatively many parts and is relatively big in size, and the flow control member 3 is a relatively long distance away from the patient who wears the hood 4. Consequently, such supplementary oxygen treatment device is not convenient to use.

Another conventional supplementary oxygen treatment device is equipped with a respirator as shown in FIG. 8 instead of the hood 4. The respirator is relatively heavy in weight, and has to be used with elastic cords, which are tightly wound around the head of the patient. However, the patient would feel very uncomfortable wearing the respirator, and pull the respirator slightly away form the face to reduce the discomfort. The patient has operate the knob 32 to increase the flow of oxygen to compensate for loss of oxygen that is caused due to presence of space between the face and the aspirator, otherwise he/she will have difficulty breathing. Consequently, the oxygen will permeate the chamber with high concentration, causing a waste of money and becoming dangerously combustible. Furthermore, such aspirators are relatively expensive, therefore they are used over and over again on different patients in the clinics, being prone to pass contagious diseases from patients to patients.

### SUMMARY OF THE INVENTION

Therefore, it is a main object of the present invention to provide such a flow controlling mechanism of an oxygen treatment device for use together with hyperbaric oxygen chamber that can change flow of gas automatically according to the force of breathing of the patient who is receiving hyperbaric oxygen treatment with the device.

It is another object of the present invention to provide a flow controlling mechanism of the same nature to an oxygen treatment device so that the treatment device can be easily used together with all kinds of aspirators and hoods, allowing the treatment device to be used conveniently.

The present flow controlling mechanism includes an inflow control valve, and an outflow control valve connected to a first conduit, and a second conduit respectively; the conduits are connected to a hood. The inflow control valve is constructed such that it can make size of the opening of an inlet thereof vary with force of the patient breathing in the oxygen in direct proportion. And, the outflow control valve is constructed such that it can make size of the opening of an outlet thereof vary with force of the patient breathing gas out in direct proportion.

### BRIEF DESCRIPTION OF THE DRAWINGS

The present invention will be better understood by reference to the accompanying drawings, wherein:

FIG. 1 is an exploded perspective view of the oxygen treatment device for use with hyperbaric chamber according to the present invention.

FIG. 2 is a plan of the flow controlling mechanism of the oxygen treatment device according to the present invention.

FIG. 3 is another plan of the flow controlling mechanism of the oxygen treatment device according to the present invention.

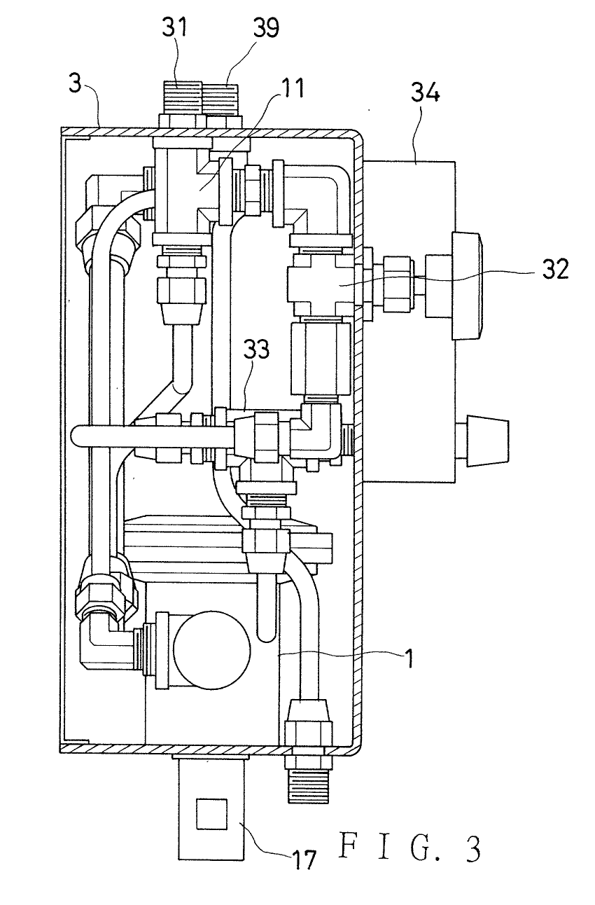

FIG. 4 is a view of the flow controlling mechanism of the present invention when it is functioning.

FIG. 5 is a view illustrating a simple mask being used together the present oxygen treatment device.

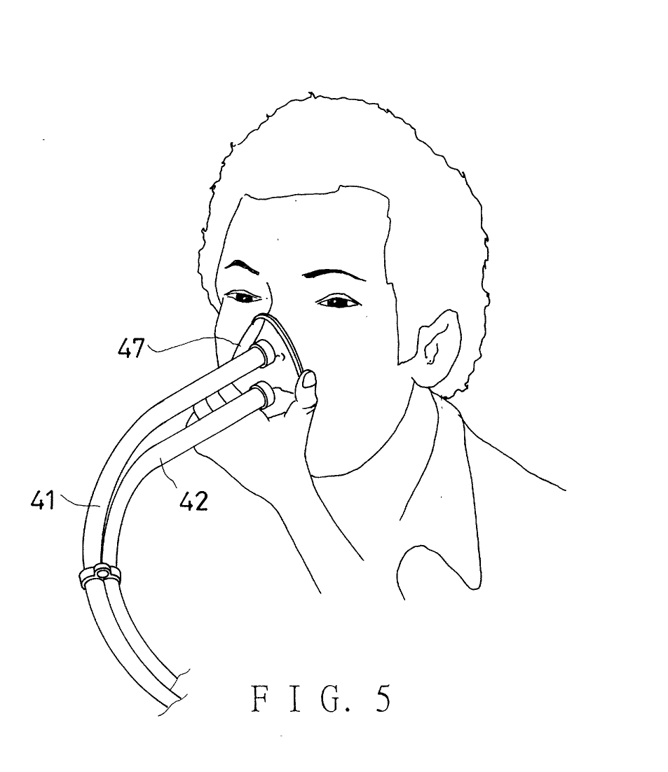

FIG. 6 is a perspective view of an oxygen treatment chamber.

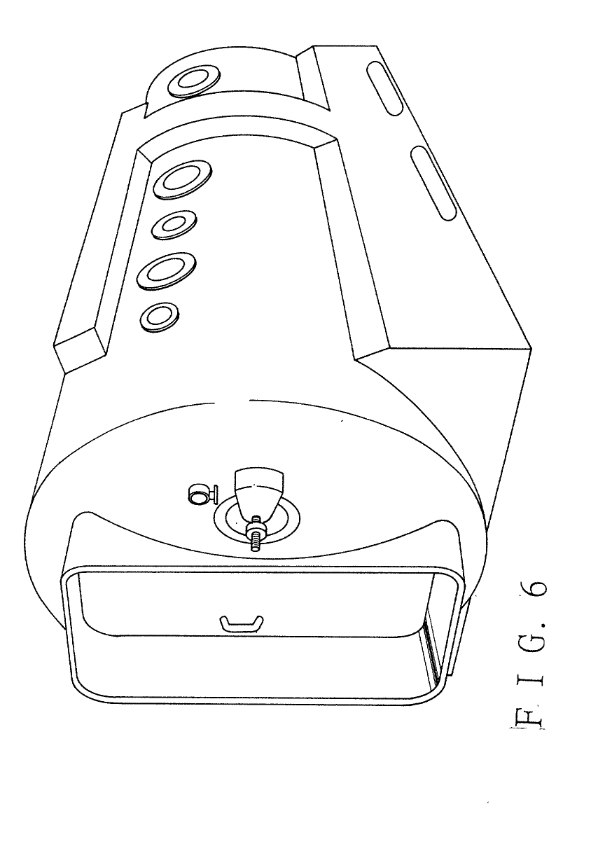

FIG. 7 is a view showing the use of the hood of the oxygen treatment device as described in the Background.

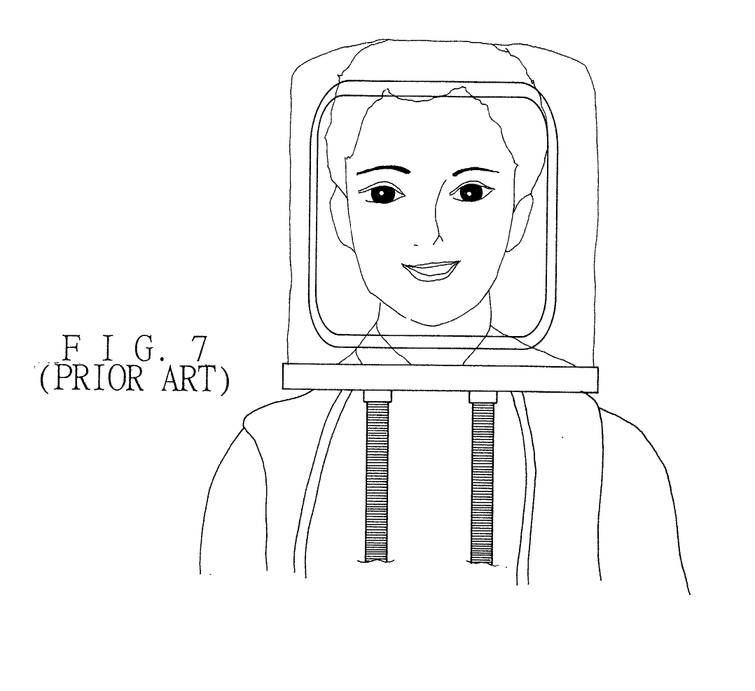

FIG. 8 is a view showing the use of the aspirator of the oxygen treatment device in the background.

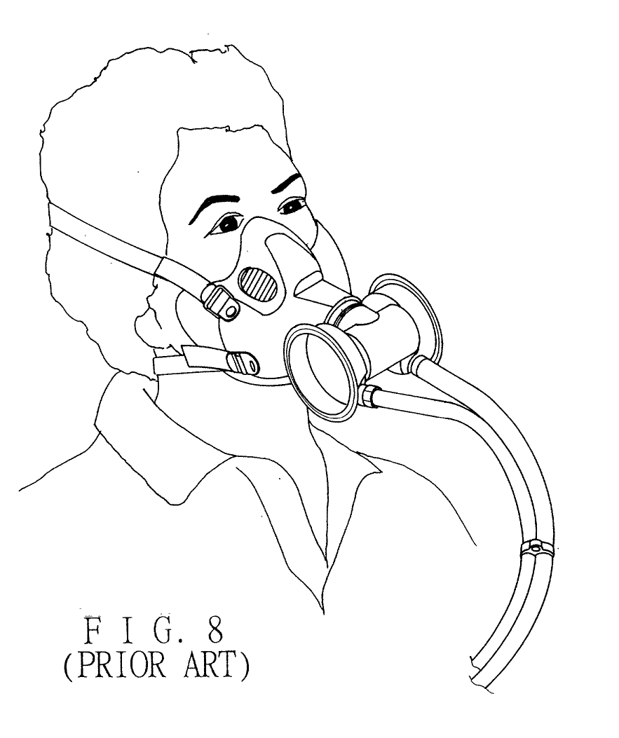

FIG. 9 is a view of the conventional oxygen treatment device,

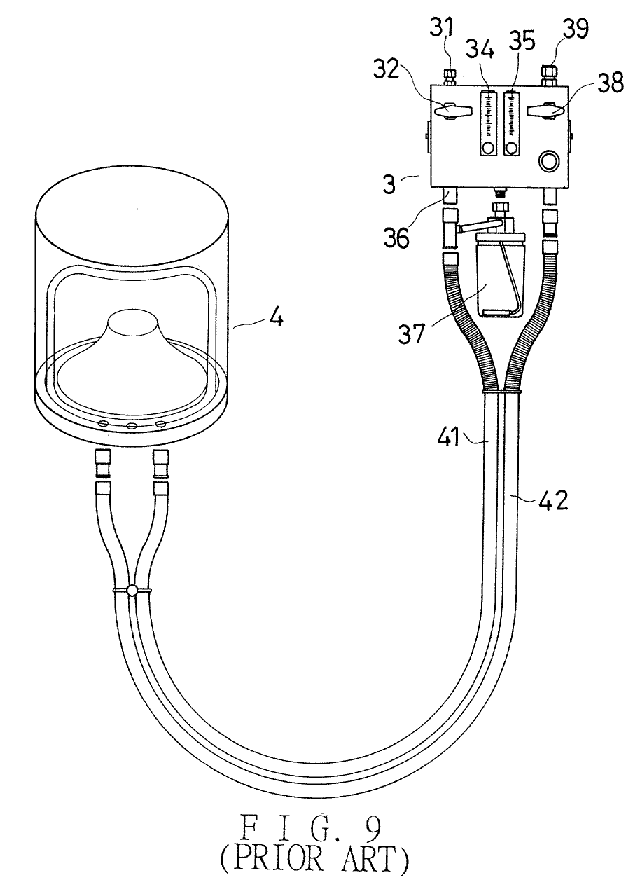

FIG. 10 is an exploded perspective view of the flow controlling member of the conventional oxygen treatment device.

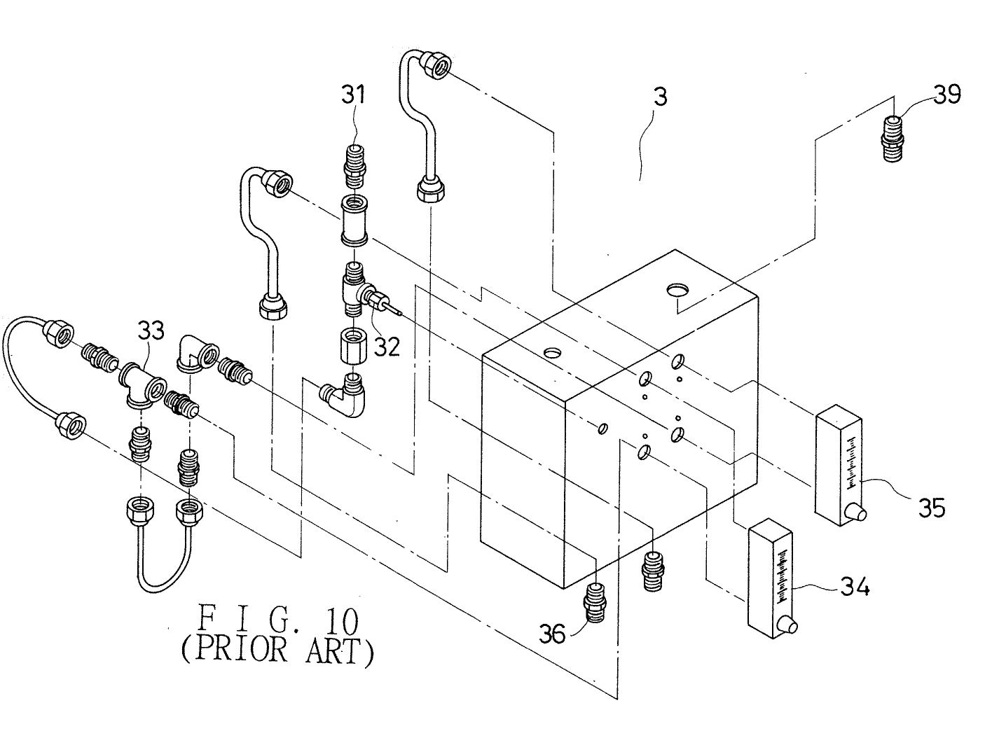

### DETAILED DESCRIPTION OF THE PREFERRED EMBODIMENTS

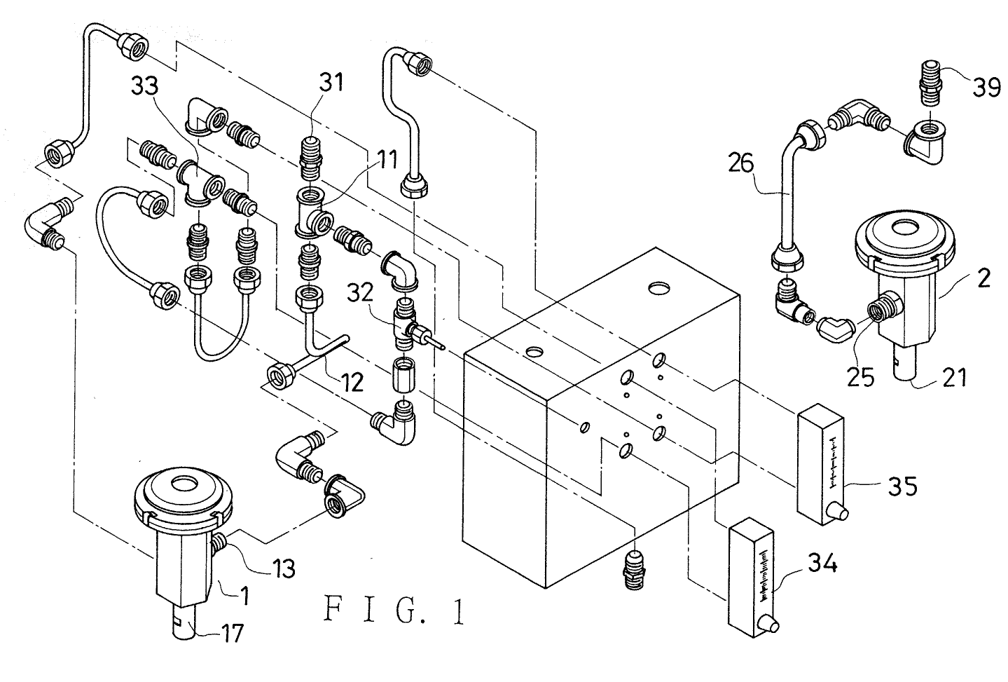

Referring to FIG. 1, a flow controlling mechanism of the present invention is provided to an oxygen treatment device. The flow controlling mechanism includes a breathing-in member, and a breathing-out member; the breathing-in member consists of an inlet pipe 31, and an inflow control valve 1, while the breathing-out member consists of an exhaust pipe 39, and an outflow control valve 2.

The inlet pipe 31 is connected to a main oxygen supply of a hyperbaric chamber at one end, and connected to an inlet tube 13 of the valve 1 at the other end by means of a three-way tube 11 as well as a conduit 12. A first conduit 41 is connected to both an outlet tube 17 of the valve land a respirator of the oxygen treatment device so that oxygen can be provided to a patient putting the aspirator on his mouth and nose.

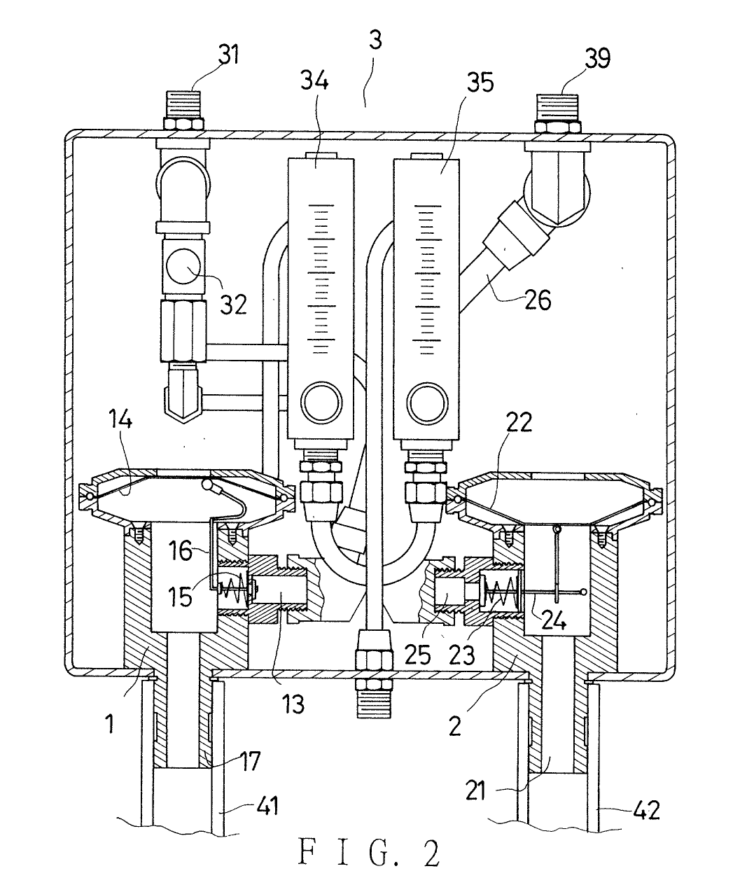

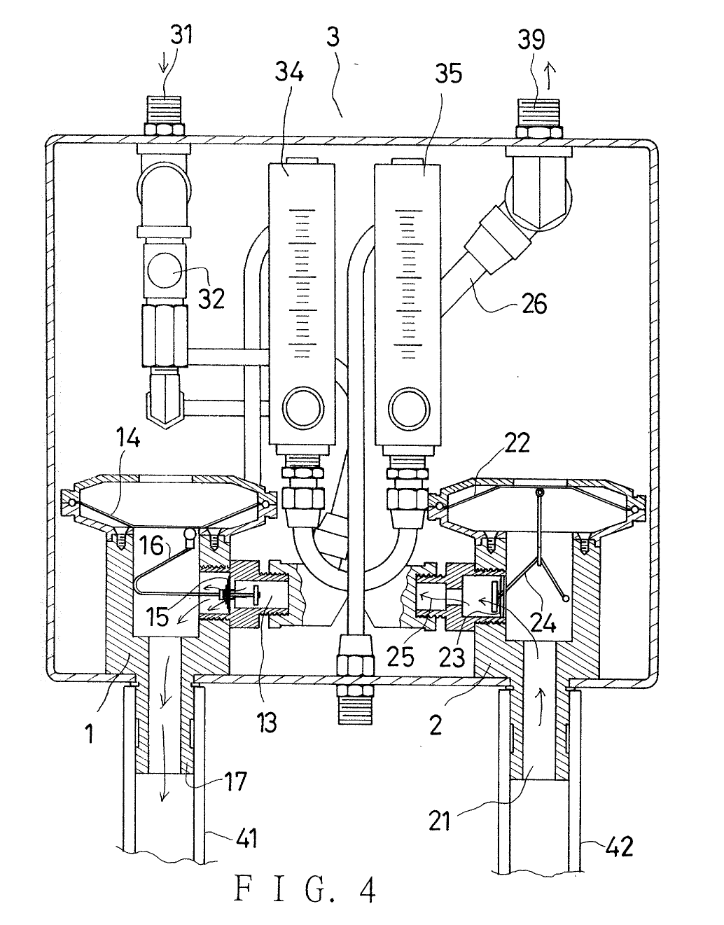

Referring to FIG. 2, the inflow control valve 1 is provided with an adjustment member, which includes a diaphragm 14, a spring 15, and a valve rod 16. The diaphragm 14 is made to curve outwardly of the housing of the valve 1 under atmospheric pressure, and can be moved to an inwardly curved position as shown in FIG. 4 by the patient breathing oxygen in. The valve rod 16 is biased to a closing position by the spring 15 to close the opening of the inlet tube 13 of the control valve 1 under atmospheric pressure, and is posed in an opening position for allowing oxygen to flow through the opening of the inlet tube 13 by the diaphragm 14 moved to the inwardly curved position. Thus, the adjustment member makes the size of the opening of the inlet tube 13 vary with force of the patient breathing in oxygen substantially in direct proportion. In other words, the control valve 1 can control the flow of oxygen into the respirator according to force of the patient breathing in.

The exhaust pipe 39 is provided for gas breathed out by the patient to flow to the atmosphere, and is connected to an outlet tube 25 of the valve 2 by means of a conduit 26. A second conduit 42 is connected to both the respirator and an inlet tube 21 of the valve 2 so that gas breathed out by the patient can travel through the valve 2.

The outflow control valve 2 is provided with an adjustment member, which includes a diaphragm 22, a spring 23, and a valve rod 24. The diaphragm 14 is made to curve inwardly of the housing of the valve2 under atmospheric pressure, and can be moved to an outwardly curved position as shown in FIG. 4 by the patient breathing out. The valve rod 24 is posed in a closing position with the diaphragm 22 in the inwardly curved position so as to close the opening of the outlet tube 25 of the control valve 2 under atmospheric pressure. The valve rod 24 is connected to the spring 23 so as to be biased to an opening position for allowing gas to flow through the opening of the outlet tube 25 by the spring 23 when the diaphragm 22 is made to curve outwardly of the housing of the valve 2 by the patient breathing gas out. Thus, the adjustment member of the valve 2 makes the size of the opening of the outlet tube 25 vary with force of the patient breathing out substantially in direct proportion. In other words, the control valve 2 can control the flow of gas traveling out of the respirator according to force of the patient breathing out.

Furthermore, like the above mentioned conventional flow controlling mechanism, the present controlling mechanism is provided with flow meters 34, and 35, which are connected to the three-way tube 33, and are respectively connected the inlet tube 13, and a humidifier (not shown) by means of conduits so that the meters 34, and 35 can read the flow of oxygen into the control valve 1, and into the humidifier respectively when oxygen travels through the same.

Because the present flow controlling mechanism is made to be able to function automatically, simple disposable masks can be connected to the conduits 41, and 42 for the use of the patient instead of the conventional hoods and respirators. And, disposable conduits can be used instead of the conventional conduits 41 and 42, too.

From the above description, it can be easily understood that the flow controlling mechanism for oxygen treatment device according to the present invention has advantages as followings:

1. Clinics and patients have an additional option of using simple disposable masks. Thus, the oxygen treatment device can be used conveniently with the present flow control mechanism.

2. The risk of respirators passing contagious diseases from patients to patients is eliminated because such simple masks are only used once or on one patient, helping the hyperbaric oxygen treatment to be up to the hygienic standard.

3. Cost is reduced because simple disposable masks can be used instead that are relatively inexpensive as compared with the conventional respirators.

4. The patients would feel much more comfortable wearing such simple masks instead of the conventional respirators, therefore they don't have to pull the masks slightly away form the face to reduce discomfort.

What is claimed is:

1. A flow controlling mechanism of an oxygen treatment device, comprising
(1) a breathing-in member including
i. an inlet pipe connected to a main oxygen supply of a hyperbaric chamber at one end;
ii. an inflow control valve connected to other end of the inlet pipe at an inlet thereof, and connected to a first conduit at an outlet thereof; the first conduit being connected to a nose and mouth member of an oxygen treatment device so that oxygen can be provided to a patient wearing the nose and mouth member; the inflow control valve being provided with an adjustment member constructed in such a manner as to be able to make size of an opening of the inlet of the valve vary with force of the patient breathing in the oxygen in substantially direct proportion;
(2) a breathing-out member including
i. an exhaust pipe connected to a gas outlet of the hyperbaric chamber at one end;
ii. an outflow control valve connected to other end of the exhaust pipe at an outlet thereof, and connected to a second conduit at an inlet thereof; the second conduit being connected to the nose and mouth member of the oxygen treatment device so that gas breathed out by the patient is allowed to flow through the outflow control valve; the outflow control valve being provided with an adjustment member constructed in such a manner as to be able to make size of an opening of the outlet of the outflow valve vary with force of the patient breathing gas out in substantially direct proportion.

2. The flow controlling mechanism of an oxygen treatment device according to claim 1, wherein the adjustment member of the inflow control valve includes a diaphragm, and a valve rod; the valve rod being biased to a closing position with a first spring to close the opening of the inlet of the inflow valve under atmospheric pressure; the diaphragm being connected to the valve rod such as to bias the same to an opening position for allowing oxygen to flow through the opening of the inlet when moved form an outwardly curved position to an inwardly curved one by the patient's breathing the oxygen in, making size of the opening of the inlet of the inflow valve vary with force of the patient breathing in oxygen in substantially direct proportion.

3. The flow controlling mechanism of an oxygen treatment device according to claim 1, wherein the adjustment member of the outflow control valve includes a diaphragm, and a valve rod; the diaphragm being capable of being positioned in an inwardly curved position under atmospheric pressure and in an outwardly curved one when the patient is breathing the oxygen out; the valve rod being connected to the diaphragm so as to be biased to a closing position with the diaphragm in the inwardly curved position to close the opening of the outlet of the outflow valve; the valve rod being biased to an opening position with a second spring for allowing oxygen to flow through the opening of the outlet when the diaphragm is positioned in the outwardly curved position, making size of the opening of the outlet of the outflow valve vary with force of the patient breathing out the oxygen in substantially direct proportion.
